(19) United States
(12) Patent Application Publication
(10) Pub. No.: US 2002/0053551 A1
(43) Pub. Date: May 9, 2002

(54) Method and apparatus for transporting latticed boom cranes

(76) Inventors: Fritz-Botho Koster, Rockenhausen (DE); Rudiger Zollondz, Hornbach (DE)

Correspondence Address: HENRY M FEIEREISEN, 350 FIFTH AVENUE, SUITE 3220, NEW YORK, NY, 10118, US

(21) Appl. No.: 10/008,020

(22) Filed: Nov. 8, 2001

(30) Foreign Application Priority Data
Nov. 9, 2000 (DE) 100 56 647.2

(51) Int. Cl. B66C 23/70

(52) U.S. Cl. 212/177

(57) ABSTRACT

In a method of transporting a latticed boom crane including counterweights for road transport by exploiting a maximum carrying capability of low loaders as well as prescribed loading height and loading width to keep the number of low loaders to a minimum, and for naval transport to implement a cost-efficient specific weight, latticed boom members of the boom are used for transporting counterweights, with the counterweights being secured in or at the boom members.

### CROSS-REFERENCES TO RELATED APPLICATIONS

This application claims the priority of German Patent Application Serial No. 100 56 647.2, filed Nov. 9, 2000, the subject matter of which is incorporated herein by reference.

### BACKGROUND OF THE INVENTION

The present invention relates to a method of transporting a latticed boom crane, and to an apparatus for carrying out the method.

In the context of transporting latticed boom cranes, it is important to optimize all the devices for road transport and rail transport as well as also naval transport. The number of low loaders should be minimized for a transport on roads while exploiting a maximum carrying capability of low loaders as well as admissible loading height and loading width. At a naval transport, either the volume being consumed or the weight will be calculated, whereby the calculation is based on the parameter that is more unfavorable.

It has already been proposed to push smaller intermediate boom members of the auxiliary boom into greater intermediate boom members of the main boom to thereby provide a better configuration for the transport. Depending on the construction of the auxiliary boom, the use of small intermediate boom members may, however, be omitted altogether so that the afore-described advantage cannot be exploited.

German Pat. No. DE-AS 1, 279, 904 describes a mobile crane having a latticed boom comprised of intermediate boom members of rectangular cross section which progressively tapers along the longitudinal axis from the foot area to the head area. As a result, individual intermediate boom members can be moved within one another to realize a reduction in volume for the transport. However, when intermediate boom members of constant cross section are involved, a nesting within one another becomes impossible.

German utility model DE-GM 1,937,030 describes a tower crane with a tower composed of intermediate boom members which are formed of angular pieces that are detachably connected together and provided in a same number as the sides of the tower. Each side of an angle piece has a width which corresponds to half the width of the tower side. When dismantled, the angular pieces can be stowed within one another in a space-saving manner. Such a stowing option is not feasible, when intermediate pieces are involved that form a fixed structural unit. Described in this prior art is also the incorporation of other crane components, such as crane ladder, inside the construction space that is formed by the assembled tower. This proposal corresponds basically to the procedure to place smaller intermediate boom members of an auxiliary boom within greater intermediate boom members of a main boom.

It would be desirable and advantageous to provide an improved method and apparatus for the transport of latticed boom cranes to obviate prior art shortcomings and to significantly reduce a required number of transport movements, regardless of the configuration of an auxiliary boom or the capability to dismantle the crane or the cross sectional constancy of the respective intermediate boom sections.

### SUMMARY OF THE INVENTION

According to one aspect of the present invention, a method includes the steps of employing latticed boom members of the boom for transporting counterweights; and securing the counterweights in place in or at the respective boom members. In this way, the ratio of volume and weight of the boom components are optimized for the transport. The securement may be implemented through force-fitting engagement. Currently preferred is however a form-fitting engagement.

According to another aspect of the present invention, an apparatus is proposed for transporting a latticed boom crane with a counterweight and an intermediate boom member, which exhibits a latticed configuration and has end sides provided with at least one connection element with an attachment point, whereby the counterweight is securely fixed in place in or at the intermediate boom member.

According to another feature of the present invention, the corner points of the counterweight has at least one attachment point for bolting this attachment point to the attachment points at the end face of the intermediate boom member which attachment points of the intermediate boom member are provided to connect intermediate boom members to one another, when the latticed boom is assembled. Suitably, each of both end faces of the intermediate boom member is used for attachment of a counterweight in order to realize an even weight distribution as a result of the symmetric arrangement.

Another option includes the connection of the counterweight to the inner side of the sidewall of the intermediate boom member by securing a fastening frame to the inner side to serve as guide, and insert and attach the counterweight in the fastening frame. Insertion of a counterweight into the fastening frame may be realized selectively from above, from the side or from the end face. Bolts, belts, chains, screws or brackets may be used to effect a securement.

Suitably, the fastening frame may be composed of sheet metal profiles which, depending on the direction of insertion of the weight element may form an open U in upward direction, to the side or to the end face. As an alternative, the fastening frame may also be composed of angular sheets and have a L-shaped configuration. Depending on the situation at hand, it also possible to combine both types of attachment of the counterweight.

According to another feature of the present invention, it is also possible to place the counterweight from the end face of the intermediate boom member onto the inner side of the bottom boom side. In this case, the own weight of the counterweight provides some positional securement which is complemented by an additional attachment.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a perspective illustration of a conventional intermediate boom member of a boom of a latticed boom crane;

FIG. 2 is a perspective illustration of a stack of counterweights according to the present invention;

FIG. 3 is a perspective illustration of an intermediate boom member during an initial phase of attachment of counterweights according to the present invention;

FIG. 4 is a perspective illustration of the intermediate boom member of FIG. 3 during a next phase of attachment of counterweights according to the present invention;

FIG. 5 is a perspective illustration of an intermediate boom member upon attachment of counterweights according to the invention by way of an alternative method to show a variation of a transport arrangement;

FIG. 6 is a perspective illustration of an intermediate boom member upon attachment of counterweights according to the invention by way of an alternative method to show another variation of a transport arrangement;

FIG. 7a is a detailed perspective illustration of a fastening frame for use in the transport arrangement of FIG. 6;

FIG. 7b is a detailed perspective illustration of another fastening frame for attachment to the boom member of FIG. 6;

FIG. 8 is a perspective illustration of a carriage for supporting stacks of counterweights; and

FIG. 9 is a perspective illustration of a base plate for supporting stacks of counterweights.

### DETAILED DESCRIPTION OF PREFERRED EMBODIMENTS

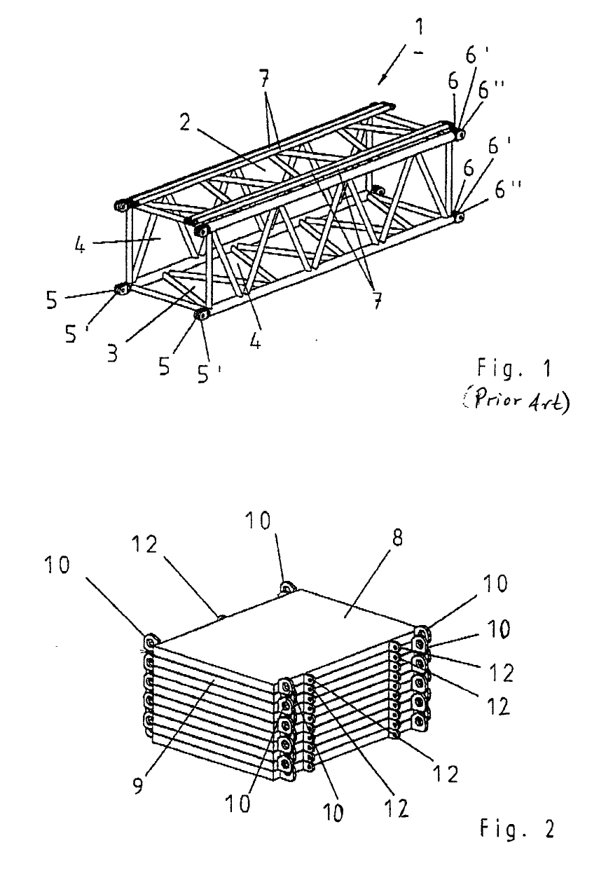

Turning now to the drawing, and in particular to FIG. 1, there is shown a perspective illustration of an exemplified conventional intermediate boom member, generally designated by reference numeral 1 and forming part of a, not shown, boom of a latticed boom crane. In the example of FIG. 1, the boom member 1 has a generally rectangular cross section, especially square cross section, and includes an upper boom side 2, a bottom boom side 3 and opposite side walls 4. At one end face, the boom member 1 is provided with connecting elements for defining two attachment points 5, 5′, and at the opposite end face, the boom member 1 is provided with connecting elements for defining three attachment points 6, 6′, 6″. The boom member 1 has been detached from other boom members of the boom and is ready for transport, with the pertaining guy rods 7 having been placed onto the upper boom side 2.

Referring now to FIG. 2, there is shown a perspective illustration of a stack of counterweights 8, 9 according to the present invention, whereby the counterweights 8, 9 are stacked in alternating sequence. Each of the counterweights 8, 9 is formed at each corner zone with an attachment point 10, whereby the attachment point 10 of counterweight 9 is positioned inwardly of the attachment point 10 of the counterweight 8 to realize the stack configuration shown in FIG. 2. In addition, each of the counterweights 8, 9 is formed on two opposite sides with at least one eyelet 12 for suspension of the counterweights 8, 9 to a, not shown, hoist, independently from the attachment points 10. In the nonlimiting example of FIG. 2, two eyelets 12 are provided on one side inwardly of the attachment points 10 and one eyelet 12 is provided on the opposite side substantially in mid-section.

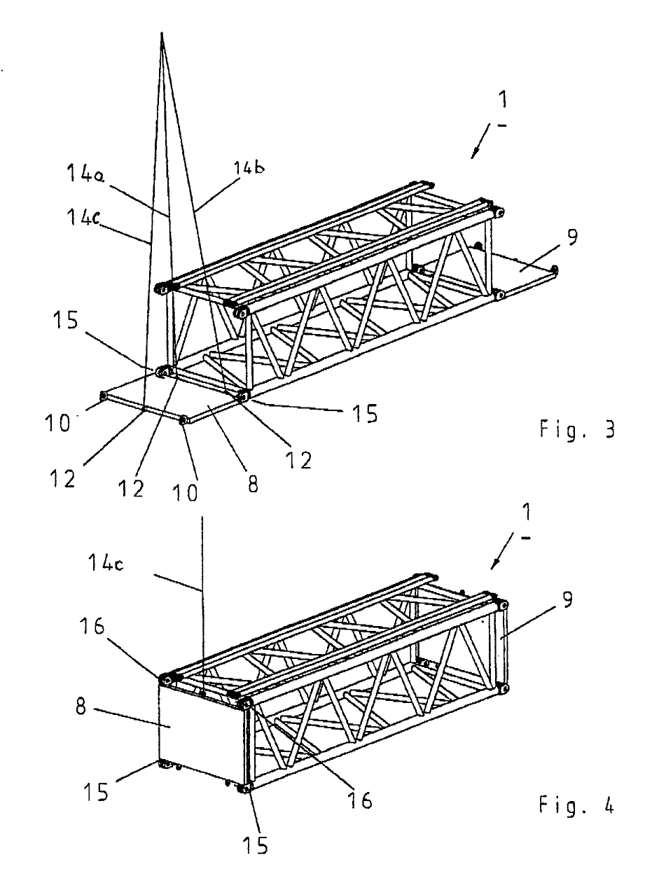

Attachment of the counterweights 8, 9 to the boom member 1 is shown in more detail in FIGS. 3 and 4, with FIG. 3 illustrating the initial phase comprised of working steps I and II, and FIG. 4 illustrating the next phase comprised of working steps III and IV. In working step I, a counterweight 8 is positioned at one end face of the boom member 1 in a way that the attachment point 10 is in alignment between the two attachment points 5, 5′ of the bottom boom side 3 of the boom member 1. FIG. 3 also shows the attachment of three ropes 14a, 14b, 14c to the respective eyelets 12. In working step II, bolts 15 are inserted through aligned bores of the attachment points 5, 10 to rotatably secure the counterweight 8 to the bottom boom side 3. After removing the inner ropes 14a, 14b, the outer rope 14c is used to swing the counterweight 8 upwards in working step III, as shown in FIG. 4, to align the outer attachment points 10 with the attachment points 5 of the upper boom side 2 of the boom member 1. After being placed through the aligned holes, bolts 16 are hammered in to secure the counterweight in position. The rope 14c can now be detached because the bolts 16 lock the counterweight 8 to the end face of the boom member 1.

A counterweight 9 is positioned and secured in a same manner at the opposite end face of the boom member 1 so that a detailed description is omitted for the sake of simplicity.

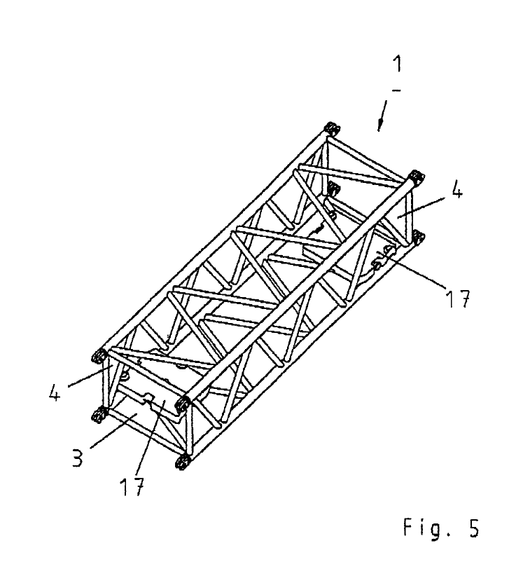

Referring now to FIG. 5, there is shown a perspective illustration of an intermediate boom member 1 upon attachment of counterweights 17 according to the invention by way of an alternative method to show a variation of a transport arrangement. The attachment of the counterweights 17 is implemented through placement of the counterweights 17 upon the inner side of the bottom boom side 3 of the boom member 1. By way of their own weight and a, not shown, fixation, e.g. brackets, the counterweights 17 can be secured immovably in place within the interior space of the boom member 1 for subsequent transport. Although not shown in detail, this type of attachment requires, however, a separate lifting device to place the counterweights 17 from the end face of the boom member 1 into the interior space thereof.

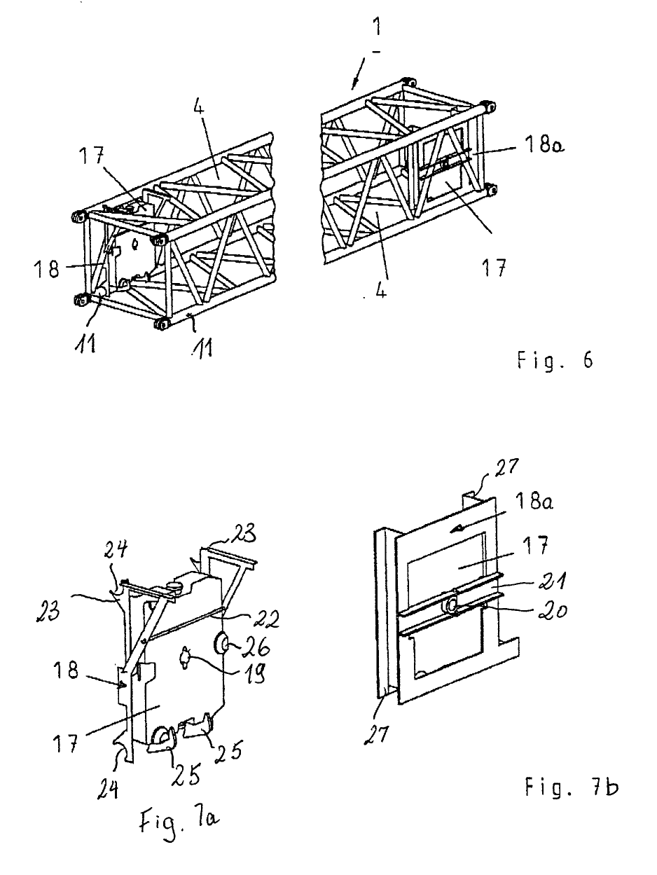

Another preferred embodiment is shown in FIG. 6. In this embodiment, opposite sidewalls 4 of the boom member 1 have attached thereon a fastening frame 18 and a fastening frame 18a. Of course, the illustration of FIG. 6 is intended for illustrative purposes to depict different types of fastening frames, but it is certainly possible to use only one or the other type for attachment of fastening frame 18, 18a. The fastening frames 18, 18a, involved here, are shown in more detail in FIGS. 7a and 7b, and so configured that the counterweights 17 can be placed from above into the fastening frame 18, 18a and secured therein. Securement of the fastening frames 18, 18a upon the sidewalls 4 of the boom member 1 may be realized in many ways, e.g., by welding, or via brackets, or by bolting. The fastening frames 18, 18a are composed of sheet metal profiles which may form an open U toward the top of the fastening frame, or toward the side of the fastening frame, or toward the end face of the fastening frame.

The fastening frame 18 of FIG. 7a has parallel profiles 23 of substantially L-shaped configuration, which have upper and lower arched pockets 24 for snap attachment to complementary struts 11 of the boom member 1. The profiles 23 are interconnected across by a retention bar 22 so as to prevent a counterweight 17, placed from above into the fastening frame 18, from tipping over. At its bottom, the fastening frame 18 includes two-spaced apart arched brackets 25 which are inwardly convex and prevent the counterweight 17 from slipping downwards. The arched configuration of the brackets 25 is intended to provide space for lobes 26 of the counterweight 17. Thus, although the square counterweight 17 may have lobes 26 in the peripheral area thereof, the counterweight 17 may be placed into the fastening frame 18 in any position, as one or the other bracket 25 is able to receive the lobes 25.

The fastening frame 18a of FIG. 7b is composed of U-shaped profiles 27, facing outwards in order to allow securement of counterweights 17 of different thickness. Each counterweight 17 is formed with a central breakthrough 19 for threaded engagement by a fastening screw 20 which is inserted from outside through an aligned hole in a crossbar 21 of the fastening frame 18a. In this way, the counterweight 17 is held securely in place within the fastening frame 18a. The central breakthrough 19 is normally already provided in the counterweight 17 to receive a tie rod, not shown, for suspension of a crane.

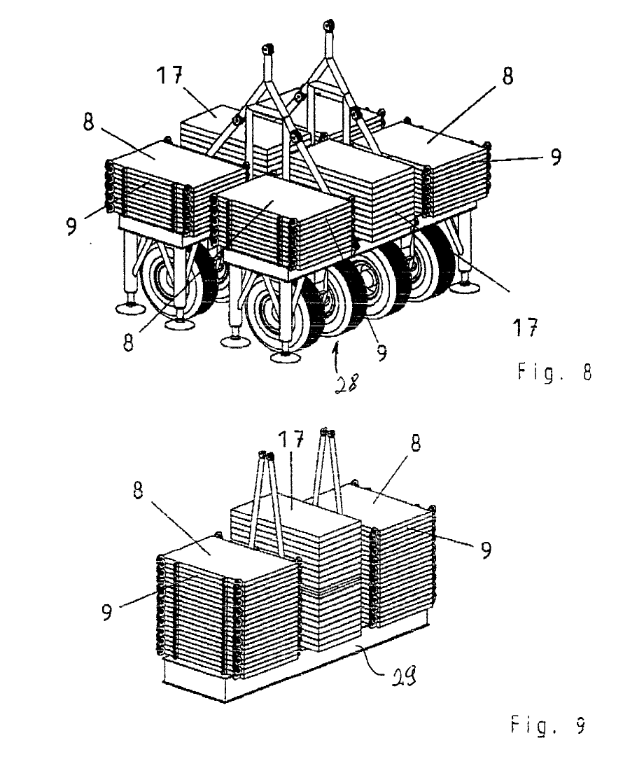

FIGS. 8 and 9 show examples of particular support devices for the counterweights 8, 9 for use in conjunction with a latticed boom crane, with FIG. 8 depicting an exemplified cart 28 upon which the counterweights 8, 9 are stacked, and with FIG. 9 depicting an exemplified base plate 29 for stacking the counterweights 8, 9.

While the invention has been illustrated and described as embodied in a method and apparatus for transporting latticed boom cranes, it is not intended to be limited to the details shown since various modifications and structural changes may be made without departing in any way from the spirit of the present invention.

What is claimed as new and desired to be protected by Letters Patent is set forth in the appended claims:

1. A method of transporting a latticed boom crane of a type including counterweights, whereby upon road transport a maximum carrying capability of low loaders as well as prescribed loading height and loading width are exploited to keep the number of low loaders to a minimum, and upon naval transport a cost-efficient specific weight is targeted, said method comprising the steps of using latticed boom members of the boom for transporting counterweights; and securing the counterweights in place in or at the boom members.

2. Apparatus for transporting a latticed boom crane having a counterweight and an intermediate boom member of latticed configuration, with the boom member having end sides provided with at least one connection element having an attachment point, wherein the counterweight is secured in place in or at the intermediate boom member.

3. The apparatus of claim 2, wherein the counterweight has corner points provided with at least one said attachment point for securement to an attachment point at an end face of the intermediate boom member.

4. The apparatus of claim 3, wherein both end faces of the intermediate boom member are connected with a one of said counterweight.

5. The apparatus of claim 2, and further comprising a fastening frame arranged on an inner side of at least one sidewall of the intermediate boom member for providing a guidance, wherein the counterweight is insertable into the fastening frame from a position selected from the group consisting of top of the fastening frame, side of the fastening frame and end face of the fastening frame.

6. The apparatus of claim 5, wherein the fastening frame is composed of sheet metal profiles which form an open U in a direction selected from the group consisting of to the top of the fastening frame, to the side of the fastening frame and to the end face of the fastening frame.

7. The apparatus of claim 5, wherein the fastening frame is composed of angular sheets forming a L-shaped configuration.

8. The apparatus of claim 5, wherein the counterweight has a central breakthrough, wherein the fastening frame includes a crossbar which is attachable to the counterweight by a fastener engageable in the central breakthrough of the counterweight.

9. The apparatus of claim 5, wherein the fastening frame has a pair of spaced-apart profiles and a retention bar interconnecting the profiles for preventing the counterweight from tipping over.

10. The apparatus of claim 9, wherein the fastening frame has at least one lower bracket to prevent the counterweight from sliding downwards.

11. The apparatus of claim 10, wherein the bracket is arched in a convex manner.

12. In a method for transporting a latticed boom crane comprised of at least one boom member and at least one counterweight, said method comprising the step of immovably securing the counterweight to the boom member.

13. The method of claim 12, wherein the counterweight is attached to an end face of the boom member.

14. The method of claim 12, wherein the counterweight is placed in a fastening frame connected to the boom member.

15. The method of claim 12, wherein a further said counterweight is immovably secured to the boom member to realize an even distribution of forces during transport of the boom member.

16. A latticed boom crane, comprising a boom member having attachment points for connection to another such boom member; and at least one counterweight having attachment points complementing the attachment points of the boom member for immovable securement of the counterweight to the boom member, when the boom member and the counterweight are readied for transport.

17. The boom crane of claim 16, and further comprising a second said counterweight for immovable securement to the boom member in symmetric relationship to the one counterweight for realizing an even force distribution during transport of the boom member and the counterweights.

18. A latticed boom crane, comprising a boom member; a counterweight; and a fastening frame connected to an inside wall of the boom member for immovable securement of the counterweight, when the boom member and the counterweight are readied for transport.

19. The boom crane of claim 18, and further comprising a second said fastening frame connected to the inside wall of the boom member in symmetric relationship to the fastening frame for immovable securement of a second said counterweight to the boom member so as to realize an even force distribution during transport of the boom member and the counterweights.

20. The boom crane of claim 18, wherein the fastening frame is composed of angular sheets forming a L-shaped configuration.
